(19) United States
(12) Patent Application Publication
(10) Pub. No.: US 2005/0115962 A1
(43) Pub. Date: Jun. 2, 2005

(54) Insulated wrap for cooking dishes

(76) Inventor: Vicki L. Bickers, Palestine, IL (US)

Correspondence Address: BOWERS HARRISON LLP;GARY K. PRICE, ESP., 25 RIVERSIDE DRIVE, PO BOX 1287, EVANSVILLE, IN, 47706-1287, US

(21) Appl. No.: 11/001,549

(22) Filed: Dec. 1, 2004

Related U.S. Application Data
(60) Provisional application No. 60/525,823, filed on Dec. 1, 2003.

(51) Int. Cl. H05B 6/78

(52) U.S. Cl. 219/754

(57) ABSTRACT

An insulated wrap that surrounds the sides and lid of a conventional cooking dish and is designed to maintain the food contained in the cooking dish warm. The insulated wrap includes a side panel that wraps around the cooking dish, and a top panel that rests on the lid of the cooking dish. The side panel includes a pair of side apertures to receive carrying handles that extend from the side of the cooking dish. The side panel wraps around the side wall of the cooking dish and encloses the parameter of the cooking dish with the carrying handles of the cooking dish extending through the side apertures. The wrap further includes fastening means that secures the side panel in position around the perimeter of the cooking dish. The top panel includes a top aperture to receive the top handle of the lid of the cooking dish. The top handle extends through the top aperture of the top panel and serves to maintain the top panel in position on the lid of the cooking dish.

### CROSS REFERENCES TO RELATED APPLICATIONS

U.S. Provisional Application for Patent No. 60/525,823, filed Dec. 1, 2003, with title “Insulated Wrap for Cooking Dishes” which is hereby incorporated by reference. Applicant claims priority pursuant to 35 U.S.C. Par. 119(e)(i).

### STATEMENT AS TO RIGHTS TO INVENTIONS MADE UNDER FEDERALLY SPONSORED RESEARCH AND Development

Not Applicable

### BACKGROUND OF THE INVENTION

1. Field of the Invention

The present invention relates generally to the field of warmers for cooking dishes, and more particularly to an insulated wrap that surrounds the top and sides of the conventional cooking dish.

2. Brief Description of Prior Art

Serving holders are well known in the art, including holders designed to maintain the food contained in the cooking dish warm. Hibbert (U.S. Pat. No. 3,507,312) discloses a fabric dish and pan holder which has an elastic around the top perimeter to snugly fit the serving dish. However, the hot dish of Hibbert is difficult to insert into its holder. The difficulty arises in attempting to maneuver the hot serving dish into the holder that has a tight fitting, elasticized opening. LaBarba (U.S. Pat. No. 3,990,459) also shows an insulated warmer and serving receptacle which does not have the problems of Hibbert, and does not fit snugly around the serving dish. With LaBarba, it is possible that the serving dish might easily slip out of the holder causing food to spill and burns to occur. Harden (U.S. Pat. No. 3,745,290) shows a serving vessel that is made of plastic, glass, and ceramic, not fabric. Thus, it is not foldable, or decorative in the sense of a fabric holder.

Therefore, a need continues to exist to provide an insulated device designed to maintain the food contained in the cooking dish warm, that is easily attached to the cooking dish, and in application, allows the user to easily carry the cooking dish without unnecessary concerns of food spills.

As will be seen from the subsequent description, the preferred embodiments of the present invention overcome the above problems and difficulties of the prior art.

### SUMMARY OF THE INVENTION

The present invention is an insulated wrap that primarily surrounds the top and sides of a conventional cooking dish and is designed to maintain the food contained in the cooking dish warm. The insulated wrap of the present invention includes a side panel that wraps around a conventional cooking dish, and a separate top panel for attaching to a lid of the conventional cooking dish. The side panel and the top panel are made of three layers. In particular, an outer layer is preferably made of a vinyl material, an inner layer is preferably made of a noncombustible material, and an inside layer disposed between the outer layer and the inner layer is preferably made of an insulation material. The side panel further includes a pair of side apertures sized and shaped to receive the carrying handles that extend from the side surface of the standard cooking dish. The side panel wraps around the side wall of the cooking dish and encloses the parameter of the cooking dish with the carrying handles of the cooking dish extending through the side apertures. The wrap further includes fastening means that secures the side panel in position around the perimeter of the cooking dish. A top aperture is positioned in the approximate center of the top panel, the top aperture sized to receive the top handle of the lid of the cooking dish. The top handle extends through the top aperture of the top panel and serves to maintain the top panel in position on the lid of the cooking dish.

### BRIEF DESCRIPTION OF THE DRAWINGS

FIG. 1 is a perspective view of a preferred embodiment of the present invention, an insulated wrap for cooking dishes.

FIG. 2 is a sectional view of the insulated wrap of FIG. 1.

FIG. 3 is a top section view of the top panel of the insulated wrap of FIG. 1.

### DESCRIPTION OF THE PREFERRED EMBODIMENT

In accordance with the present invention, an insulated wrap for cooking dishes is disclosed. The insulated wrap provides a device that surrounds the top and sides of a conventional cooking dish to keep the food within the cooking dish warm, and to retain the warmth therein. Specifically, it will be noted in the drawings that the insulated wrap relates to a device that wraps around the sides of the cooking dish, and further includes a top panel which positions to the top of the cooking dish in order to insulate the cooking dish and the contents therein. In the broadest context, the insulated wrap consists of components configured and correlated with respect to each other so as to attain the desired objective.

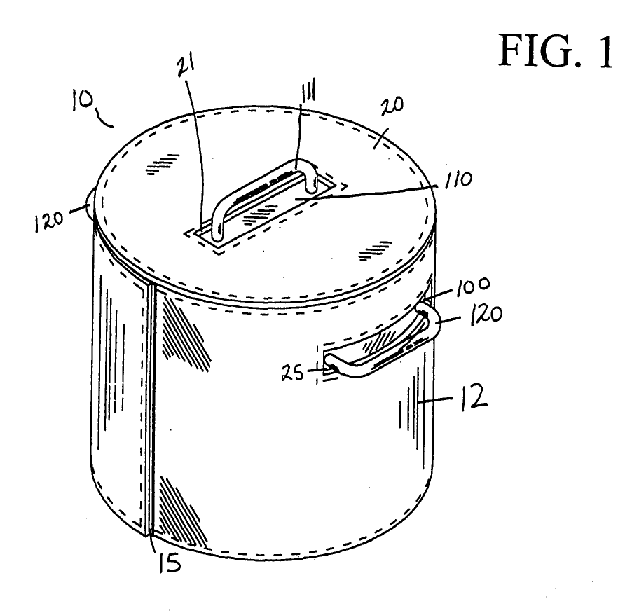

FIGS. 1-3 illustrate the preferred embodiment of an insulated wrap 10 made in accordance of the present invention. As shown in the drawings, the insulated wrap 10 includes an elongated side panel 12 that wraps around a conventional cooking dish 100. The side panel 12 includes fastening means 15 for connecting the ends of the side panel 12 as will be further described. In application, the side panel 12 upwardly extends the peripheral side wall of the cooking dish 100. The elongated side panel 12 preferably has an approximate rectangular configuration.

The insulated wrap 10 further includes a top panel 20 for attaching to a lid 110 of the conventional cooking dish 100. As will be understood, the side panel 12 and the top panel 20 are separate from one another. As such, the panels 12 and 20 may be used together or distinct from the other.

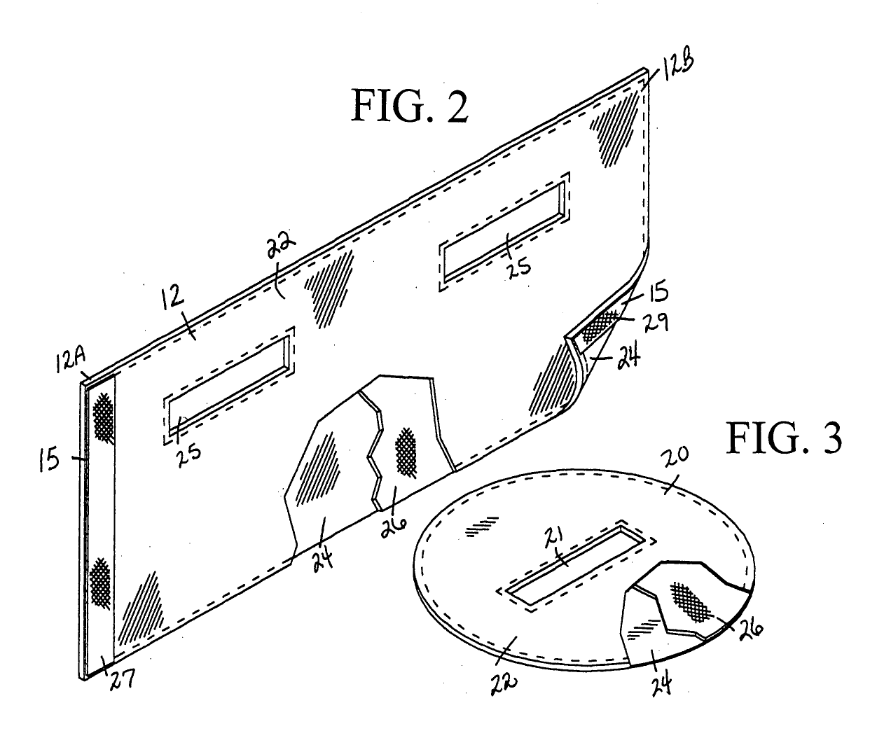

In the preferred embodiment, the side panel 12 and the top panel 20 are made of three layers. In particular, an outer layer designated in FIGS. 2 and 3, as numeral 22 is preferably made of a vinyl material, an inner layer designated as numeral 24 is preferably made of a noncombustible material, and an inside layer 26 sandwiched between the outer layer 22 and the inner layer 24 is preferably made of an insulation material. The outer layer 22 may be of a decorative nature to enhance the appearance of the insulated wrap 10.

As is customary with cooking dishes there are a pair of opposed carrying handles 120 to grip the serving dish 100 when transporting the serving dish 100. The side panel 12 further includes a pair of side apertures 25 sized and shaped to receive the carrying handles 120 that extend from the side of the cooking dish 100.

In application, the side panel 12 is wrapped around the peripheral side wall of the cooking dish 100. In position, the side panel 12 encloses the parameter of the cooking dish 100. The purpose of the side apertures 25 are to receive the carrying handles 120 of the cooking dish 100 therethrough so that the side panel 12 is allowed to wrap around the cooking dish 100 snugly, and so that the inner layer 24 of the entire side panel 12 is in contact with the side wall of the cooking dish 100 as shown in FIG. 1. The carrying handles 120 each extend through one of the side apertures 25 as shown in FIG. 1 and further maintains the side panel 12 in place in relation to the peripheral side wall of the serving dish 100.

In the preferred embodiment, the fastening means 15 is formed of a hook-like member and pile-like member adapted to be engaged by and held securely by the hook-like member. The fastening means 15 as described above can be pulled apart, which will separate the hook-like member from the pile-like member. The preferred embodiment uses a fastener sold under the trademark VELCRO. It is envisioned that other relatable fasteners may be used.

In order to wrap the side panel 12 around the serving dish 100 as described above, a fastening strip 27 is sewn on the outside surface of a first end 12A of the side panel 12. A corresponding fastening strip 29 is attached on the inside surface of a second end 12B of the side panel 12. The first end 12A of the side panel 12 is opposite the second end 12B. When the first end 12A of the side panel 12 is positioned around the perimeter of the cooking dish 100 the invention encloses the cooking dish 100 and closes securely around the cooking dish 100, as the corresponding fastening strips on either end of the side wall 12 are overlapped and pressed together. In position, the inner layer 24 of the side panel 12 is in abutting relationship with the peripheral side wall of the cooking dish 100.

The conventional cooking dish 100 often includes a top handle 111 that upwardly extends from the outer surface of the lid 110 of the cooking dish 100 for removing the lid 110 from the cooking dish 100. The top panel 20 generally has a configuration similar to the shape of the lid 110, most often circular. A top aperture 21 is positioned in the approximate center of the top panel 20. The top aperture 21 is sized and shaped to receive the top handle 111 of the lid 110 of the cooking dish 100. In application, the top handle 111 extends through the top aperture 21 of the top panel 20 and serves to maintain the top panel 20 in position on the lid 110 of the cooking dish 100. In position, the inner layer 24 of the top panel 20 is in abutting relationship with the outer surface of the lid 110 of the cooking dish 100.

The use of the insulated wrap 10 as disclosed herein has been described for insulating hot cooking dishes of food. It is also envisioned that the cooking dishes may contain chilled food, thus the insulating factor aids in keeping the food cold, as well as hot.

The shape of the cooking dish holder 10 could be in a wide variety of geometric shapes, the significant factor being the shape and dimension of the exterior surface of the cooking dish to be insulated.

Although the description above contains many specificities, these should not be construed as limiting the scope of the invention but as merely providing illustrations of some of the presently preferred embodiments of this invention. As such, it is to be understood that the present invention is not limited to the embodiments described above, but encompasses any and all embodiments within the scope of the claims.

It will be obvious to those skilled in the art that modifications may be made to the embodiments described above without departing from the scope of the invention. Thus the scope of the invention should be determined by the claims in the formal application and their legal equivalents, rather than by the examples given.

1. An insulated wrap comprising:
a first panel that wraps around a conventional cooking dish, wherein said cooking dish having a pair of carrying handles that extend from the cooking dish,
said first panel includes a pair of apertures sized and shaped to receive said carrying handles,
fastening means to secure the first panel around the perimeter of the cooking dish,
wherein the first panel further comprising an outer layer, an inner layer, and an inside layer sandwiched between the second outer and inner layers.

2. The insulated wrap as recited in claim 1, further comprising a second panel having a top aperture positioned in the approximate center of the second panel, said top aperture sized to receive a top handle of a lid of the cooking dish,
said second panel further comprising a second outer layer, a second inner layer, and a second inside layer sandwiched between the second outer layer and the second inner layer.

3. The insulated wrap as recited in claim 1, wherein the outer layer is made of a vinyl material.

4. The insulated wrap as recited in claim 1, wherein the inner layer is made of a noncombustible material.

5. The insulated wrap as recited in claim 1, wherein the inside layer is made of an insulation material.

6. The insulated wrap as recited in claim 2, wherein the second outer layer is made of a vinyl layer material.

7. The insulated wrap as recited in claim 2, wherein the second inner layer is made of a noncombustible material.

8. The insulated wrap as recited in claim 2, wherein the second inside layer is made of an insulation material.

9. An insulated wrap that surrounds the sides and lid of a conventional cooking dish, the insulated wrap comprising:
a side panel that wraps around a conventional cooking dish,
a top panel that rests on a lid of the conventional cooking dish,
wherein the side panel further includes a pair of side apertures sized and shaped to receive carrying handles that extend from the conventional cooking dish,
fastening means attached to the side panel that secures the side panel around the perimeter of the cooking dish,
wherein the top panel includes a top aperture positioned in the approximate center of the top panel, said top aperture sized to receive a top handle of the lid of the cooking dish.

10. The insulated wrap as recited in claim 9, wherein the side panel further comprising an outer layer, an inner layer and an inside layer sandwiched between the outer and the inner layers.

11. The insulated wrap as recited in claim 9, wherein the top panel comprising a second outer layer, a second inner layer, and a second inside layer sandwiched between the second outer layer and the second inner layer.

12. The insulated wrap as recited in claim 10, wherein the outer layer is made of a vinyl material.

13. The insulated wrap as recited in claim 10, wherein the inner layer is made of a noncombustible material.

14. The insulated wrap as recited in claim 10, wherein the inside layer is made of an insulation material.

15. The insulated wrap as recited in claim 11, wherein the second outer layer is made of a vinyl material.

16. The insulated wrap as recited in claim 11, wherein the second inner layer is made of a noncombustible material.

17. The insulated wrap as recited in claim 11, wherein the second inside layer is made of an insulation material.

18. An insulated wrap that surrounds the sides and lid of a conventional cooking dish, the insulated wrap comprising:
a side panel, said side panel including a pair of side apertures sized and shaped to receive carrying handles that extend from a conventional cooking dish,
a top panel, said top panel including a top aperture sized and shaped to receive a top handle of a lid of the cooking dish,
said side panel further including fastening means to secure the side panel around the perimeter of the cooking dish,
said side panel further comprising at least one side layer made of a noncombustible material,
wherein the top panel further comprising at least one top layer made of a noncombustible material.

19. The insulated wrap as recited in claim 18, wherein the side panel further comprising a side outer layer and a side inside layer sandwiched between the side outer layer and the at least one side layer.
